(19) United States
(12) Patent Application Publication
(10) Pub. No.: US 2003/0017846 A1
(43) Pub. Date: Jan. 23, 2003

(54) Wireless display

(76) Inventors: Leonardo W. Estevez, Rowlett, TX (US); Frank J. Moizio, Dallas, TX (US); Mary A. DuVal, Farmers Branch, TX (US); William M. Bommersbach, Richardson, TX (US)

Correspondence Address: TEXAS INSTRUMENTS INCORPORATED, P O BOX 655474, M/S 3999, DALLAS, TX, 75265

(21) Appl. No.: 10/167,790

(22) Filed: Jun. 12, 2002

Related U.S. Application Data
(60) Provisional application No. 60/297,565, filed on Jun. 12, 2001.

(51) Int. Cl. H04H 1/00; H04M 1/00; H04B 1/38

(52) U.S. Cl. 455/556; 455/3.01; 455/3.05

(57) ABSTRACT

A wireless link between a hand-held or portable device and a display device (projector). The highly optimized, DSP generated, graphic rendering code and JPEG decompression code provides the real-time rendering requirements necessary to offer cable-like connectivity from a remote device to a wireless projector. The projector is capable of receiving, decompressing, decoding, and displaying images in real-time. The system of the present invention incorporates digital signal processor (DSP) accelerated 802.11 compression and encryption capability, which is provided in a standard 802.11 PCMCIA card format. In one application, the hand-held device displays a low-resolution version of a particular image, such as a thumbnail, and may also provide a list of images available for display on the projector at full-resolution. Interactive Codec (coder/decoder) capability for use in remote PC video applications is also provided. The Codec iteratively compresses sub-sampled on-screen video data locally starting with less computationally complex techniques with the viewer interactively increasing the complexity until acceptable data is presented.

This application claims priority under 35 U.S.C. § 119(e)(1) of U.S. patent application Ser. No. 60/297,565 filed 12 Jun. 2002.

### FIELD OF THE INVENTION

The present invention relates to wireless image transfer and more particularly to transmitting an image from a portable device to a wireless projector.

### BACKGROUND OF THE INVENTION

Typical wireless display systems provide video output data, either compressed or non-compressed, over a wireless link. The approach provides video packets from bit-map detection using a technique known as screen scraping. At the transmission gateway, the packets of transmitted bit-map data are pieced back together and fed to the system's display buffer, and then to the display.

There is a need for a new and improved method of handling this wireless transmission by automatically compressing and encrypting the data before it is transmitted. In this regard, the present invention substantially fulfills this need. In general, a graphics device interface (GDI) mirror driver system is used to compress bitmap data prior to transmitting the data via an 802.11 wireless link to an embedded display system. The display system then interprets the GDI commands and decompresses the bitmap data before rendering it to a display subsystem.

### SUMMARY OF THE INVENTION

In general, the present invention discloses a method and system for transmitting video data from a portable device, such as a notebook computer, to a display by capturing the computer's graphics device interface (GDI) using a mirror driver and encapsulating it in a proprietary data packet format prior to transmission. This information is then transmitted over an 802.11 wireless link to a data handler at the receiver end where it is pieced back together and rendered to a video display screen at the desired rate. The display system is capable of receiving, decompressing, decoding, and displaying the video images in real-time.

More particularly, one embodiment of the present invention uses optimized digital signal processor (DSP) accelerator compression/encryption and decoding/decompression techniques and is capable of compressing, encrypting, transmitting, receiving, decompressing, decoding, and displaying the video images in real-time. Highly optimized graphic rendering code and JPEG decompression code allows the DSP to support the real-time rendering requirements necessary to provide cable-like connectivity from a remote device to a wireless projector.

The disclosed system reduces the weight and size and increases the speed of giving a presentation using existing software applications such as Microsoft™ PowerPoint™. The system supports enhanced wireless capability for any number of hand-held devices, including personal digital assistants (PDA), digital cameras, cell phones, notebook computers, and other portable devices.

In addition, the system provides an interactive coder/decoder (Codec) for remote PC video for use with remote graphic terminals with high refresh rates. In this application, the Codec iteratively compresses sub-sampled on-screen video data locally, first using less computationally complex techniques and then increases the computational complexity until acceptable data compression is acquired. Both the data and level of compression used are then transmitted to the remote terminal for reconstruction.

It is an object of the present invention to provide a new and improved wireless projector that has a low cost of manufacture with regard to both materials and labor.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a drawing showing the display appliance of the present invention where small handheld or portable devices are used to send wireless information to small, bright displays.

FIG. 2 is a drawing illustrating how the system can be used with the Internet to send data from a remote site to portable devices, which are then transmitted over the wireless link of the present invention to a projector.

FIG. 3 is a drawing illustrating laptop computer connectivity using the wireless display interface of the present invention.

FIG. 4 is a drawing showing an 802.11 PCMCIA card, which incorporates the encryption, compression, and transmission capability of the present invention, along with the bit-map data being transmitted to the projector.

FIG. 5 is a drawing illustrating the personal digital assistant connectivity using the wireless display interface of the present invention.

FIG. 6 shows an example where information is compressed and transferred from a desktop computer to a personal digital assistant and then further transmitted over a wireless link to a projector using the techniques of the present invention.

FIG. 7 illustrates the use of a wireless video projector in a home entertainment application, thereby eliminating the need to run video cables to the projector.

FIG. 8 is a drawing of the wireless display showing the added wireless components at the projector.

FIG. 9 is a functional block diagram for the wireless display of the present invention.

### DETAILED DESCRIPTION OF THE PREFERRED EMBODIMENTS

The present invention discloses a wireless link between a hand-held or portable device and a display device. In general, a graphics device interface (GDI) mirror driver system is used to compress bit-map data prior to transmitting the data via an 802.11 wireless link to an embedded display system. The display system then interprets the GDI commands and decompresses the bit-map data before rendering it to a display system.

The graphics device interface from the computer's operating system is captured using a mirror driver and encapsulated in a proprietary packet format. The data is then compressed and encrypted prior to being transmitted over an 802.11 wireless link to a data handler at the display where it is pieced back together and rendered to the display screen at the desired rate. One embodiment of the present invention uses highly optimized digital signal processor (DSP) accelerator graphics rendering code and JPEG decompression code to support the real-time rendering requirements necessary to translate the graphic commands from the host-computing device to bit-maps displayed on the wireless display in order to provide cable-like connectivity from a remote device to a wireless display.

The display system is capable of receiving, decompressing, decoding, and displaying the video images in real-time. The present invention reduces the weight and size and increases the presentation speed of the system, thereby allowing various video formats to be transmitted.

Additionally, interactive Codec (coder/decoder) capability for use in remote PC video applications is also provided. The Codec iteratively compresses sub-sampled on-screen video data locally, starting with less computationally complex techniques with the viewer interactively increasing the complexity until acceptable data is presented.

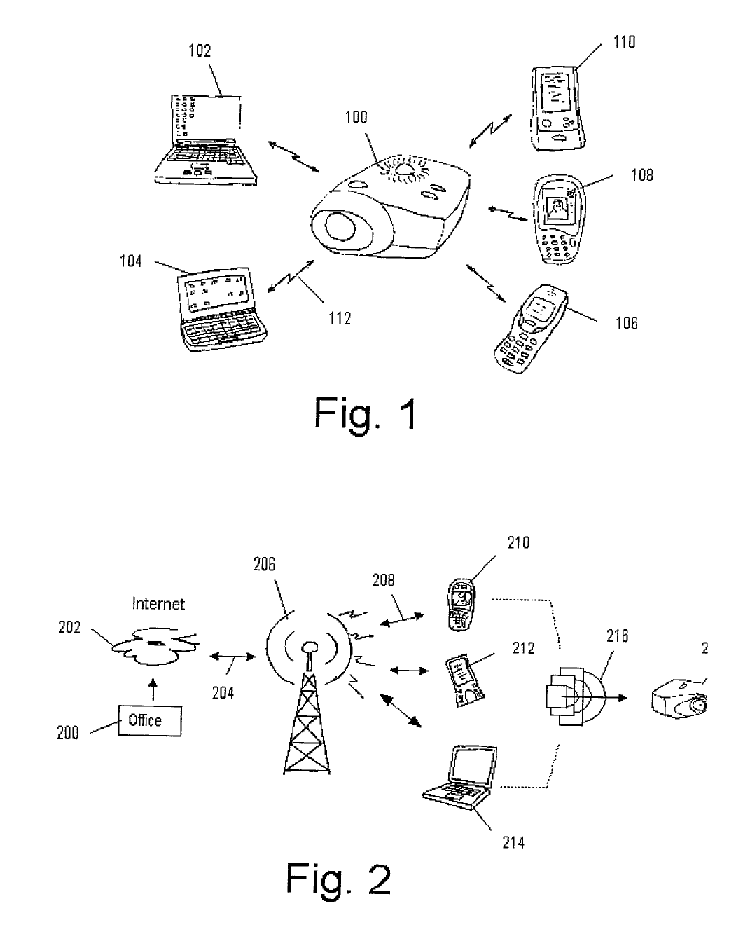

FIG. 1 is a drawing showing the display appliance of the present invention where small handheld or portable devices are used to send wireless information to a projection display 100. Examples of devices include a personal computer (PC) 102, a personal digital assistant (PDA) 104, a cell phone 106 for data transmission, a picture phone 108 for teleconferencing, and a Palm-type device 110. Other portable and/or hand-held devices that incorporate the wireless interface of the present invention can also be used. The transmission range 112 for the present invention, between the hand-held devices and the wireless projector, is at least forty-five feet.

FIG. 2 is a drawing illustrating how the system of FIG. 1 can be expanded and used with the Internet to send data from a remote site to portable devices, which are then transmitted over the wireless link of the present invention to the projector. In this example, data from an office 200 or other remote site is sent over the Internet 202, supplied 204 to a transmitter 206 and sent over a radio frequency (RF) link 208 to the hand-held and/or portable devices 210-214. The back-end portion of the system, where the data is sent over a wireless link 216 to a projector 218, is the same as described in FIG. 1.

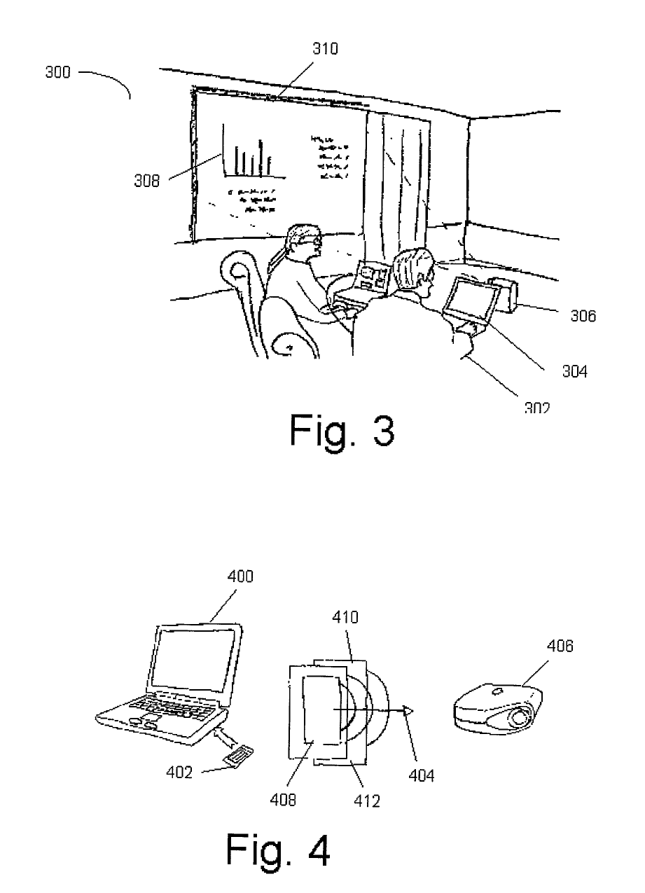

FIG. 3 is a drawing illustrating laptop computer connectivity using the wireless display interface of the present invention. In this conference room environment 300, the presenter 302 is sending a computer generated presentation 308 over a wireless link (not shown) from a PC 304 to a projector 306, which projects an image on to a display screen 310.

FIG. 4 is a drawing showing a portable PC 400 with an embedded 802.11 PCMCIA card 402, with data represented as image bit-map planes 408-412 being sent over a wireless link 404 to a projector 406. In this example a DSP provides the graphics-rendering engine required to translate the graphic commands from the host computing device 400 to bit-maps 408-412, which are then displayed on the wireless projector 406. Here an 802.11 PCMCIA card 402, which fits into the PC 400, locally incorporates the encryption, compression, and transmission capability of the present invention at the front-end of the system. The projector 406 has receiving, decoding, and decompression capability either built-in or connected from a nearby component.

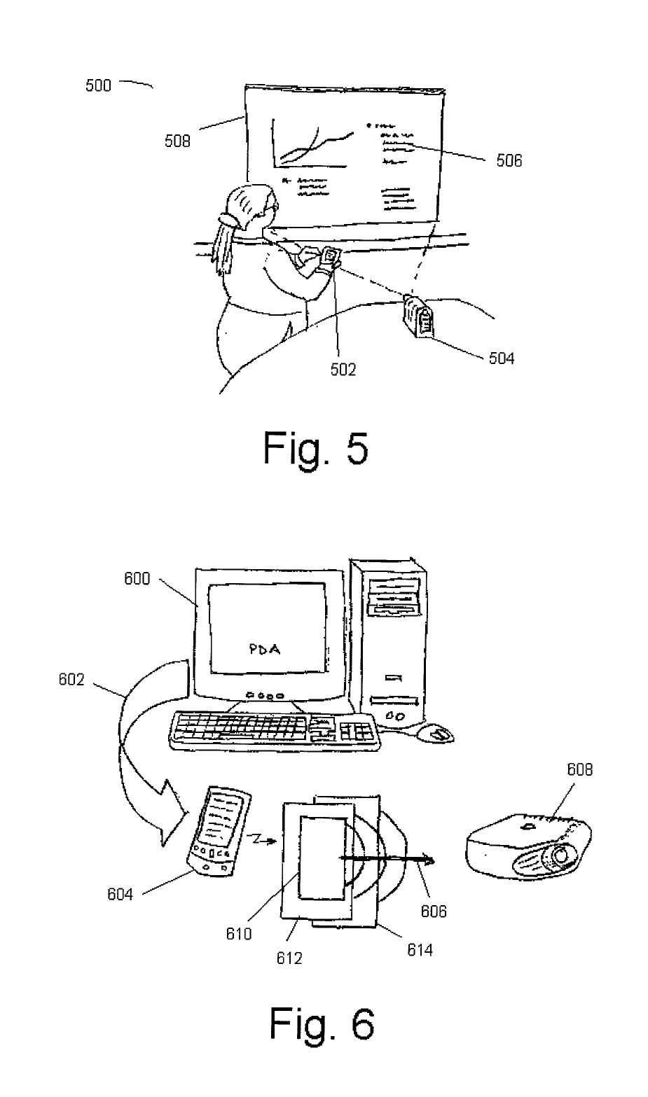

FIG. 5 is a drawing illustrating another conference room application 500 where personal digital assistant (PDA) connectivity is used with the wireless display interface of the present invention. Here, the presenter selects data from her PDA 502 for transmission over the wireless link (not shown) to the projector 504. The data 506 is then projected on to the display screen 508. In this case the software is used to translate the native presentation, such as Microsoft PowerPoint™ charts, into graphic commands that are transferred to the wireless projector 504. The hand-held device typically displays a low-resolution version of a particular image, such as a thumbnail, and may also provide a list of images available for display on the projector at full-resolution. The user can select an image from the list to initiate the transfer of a compressed image to the display device. This provides high-speed, high-brightness presentations to be made using small, portable equipment without any direct connectivity (cables).

FIG. 6 shows an example where information is compressed and transferred 602 from a desktop computer 600 to a personal digital assistant 604 and then transmitted 606 as image bit-map planes 610-614 over a wireless link 606 to a projector 608 using the techniques of the present invention.

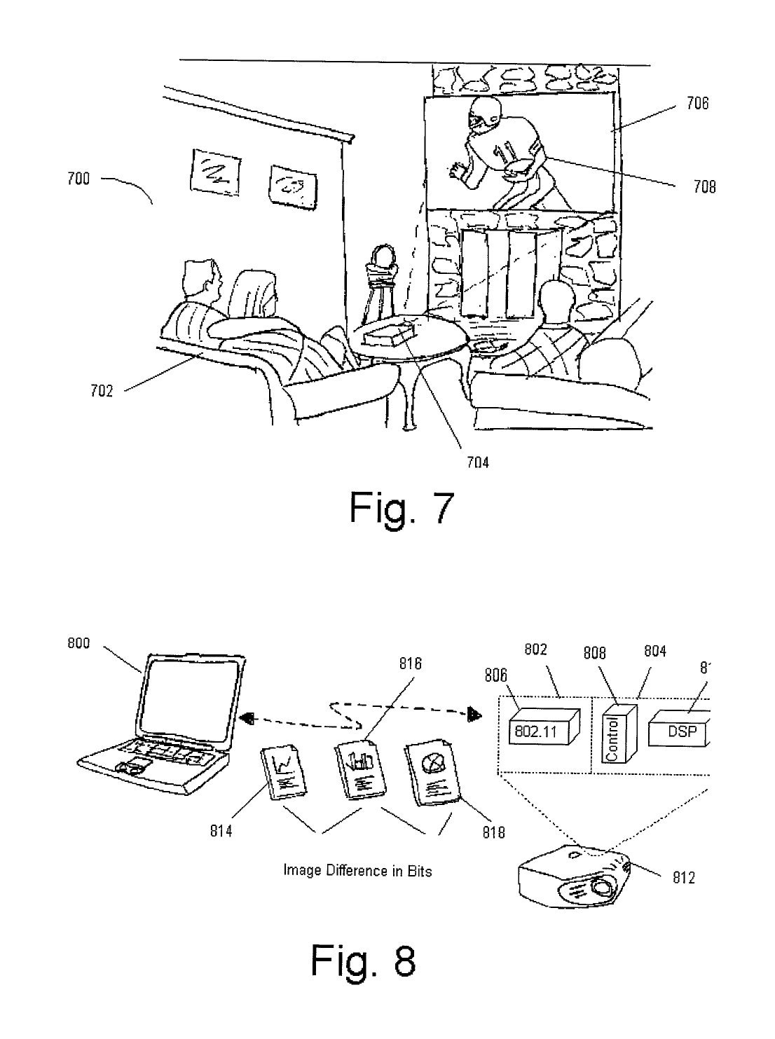

FIG. 7 illustrates the use of a wireless video projector in a home entertainment application 700. Here the family members 702 watch video 708 that is received by a wireless projector 704, which incorporates the wireless transmission method and/or system of the present invention. The video is projected from the projector 704 on to a large display screen 706. This high-speed wireless approach to home entertainment involves quick and easy setup and avoids the expensive and trouble of having to wire the home with necessary video cables.

FIG. 8 is a drawing of the wireless display for the preferred embodiment of the present invention showing the added wireless components 806-810 at the projector 812 end. In this example the DSP provides the graphics-rendering engine required to translate the graphic commands from the host computing device 800 to bit-map planes 814-818, which are then displayed on the wireless projector 812. More specifically, a notebook computer 800 with a PCMCIA or embedded board 802.11 accelerator transmits image bit-map differences 814-818 to the projector, which has an external box or embedded input capability. This input includes a RF section 802 and a DSP decompression, decoding, and control section 804. The RF section 802 includes a PCI 802.11b card 806 and a PCI bridge (not shown) coupling to the DSP section 804. The DSP section contains all the DSP functions 810 and necessary control functions 808.

In operation, the software mirrors all the Windows operating system GDI function calls and transfers them out at a standard 802.11b socket. When an 802.11b wireless network connection in made between the laptop 800 and the wireless projector 812, all graphics data appearing on the laptop monitor will appear on the wireless projector.

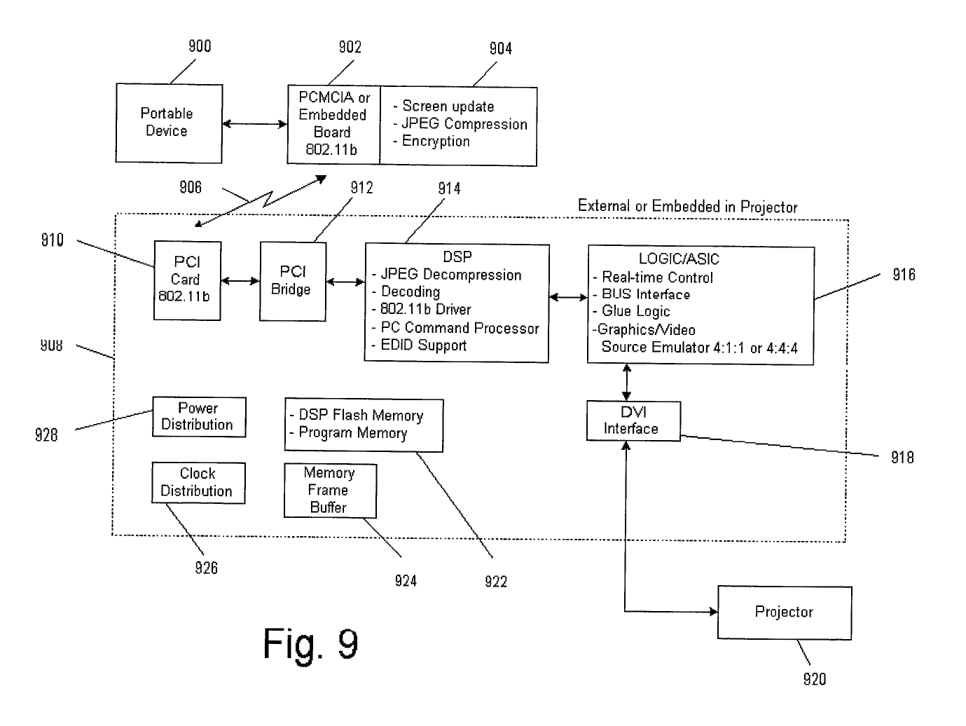

FIG. 9 is a functional block diagram for the wireless display for the preferred embodiment of the present invention. The portable device 900 has either PCMCIA or embedded 802.11 902 capability, along with JPEG compression/encryption and screen update circuitry 904. Data is transmitted over a wireless link 906 to the projector's 920 external or embedded input board 908. The data is received by a PCI 802.11b card 910 and is then coupled to the DSP circuitry 914 by a PCI bridge 912. The DSP circuitry 914 performs the functions of decompressing and decoding, as well as providing the 802.1b driver, a PC command processor, and EDID support functions. The board 908 also includes a logic application specific integrated circuit (ASIC) 916 for providing functions, such as real-time control, BUS interface, graphics/video, 4:1:1 or 4:4:4 source emulation, and necessary glue logic. Additionally, the board 908 includes program and DSP flash memory 922, a memory frame buffer 924, clock 926 and power 928 distribution functions and a DVI interface 918.

While this invention has been described in the context of both a general method and a preferred embodiment, it will be apparent to those skilled in the art that the present invention may be modified in numerous ways and may assume embodiments other than that specifically set out and described above. Accordingly, it is intended by the appended claims to cover all modifications of the invention that fall within the true spirit and scope of the invention.

What is claimed is:

1. A method for wireless image transfer, the method comprising:
compressing video bit-map data in a portable device using a graphics device interface mirror driver system;
encrypting said compressed video data in said portable device using said mirror driver system;
transmitting said video data over a wireless radio frequency link for display by a wireless display device.

2. The method of claim 1, further comprising:
using digital signal processor accelerator encryption techniques for encrypting data originating in said portable device prior to transmitting over said wireless link.

3. The method of claim 1, further comprising:
using digital signal processor accelerator decoding techniques in said display device for decoding said video data prior to displaying said data.

4. The method of claim 1, wherein said portable device is a personal computer using a Codec with a remote high-refresh rate graphics terminal, said method further comprising:
iteratively compressing sub-sampled on-screen video locally at said computer using minimal computational complex techniques; such that
if compression is acceptable, transmitting said video data over said wireless link to said remote wireless interface module;
otherwise, increasing the complexity of said compression technique until compression is acceptable; and
transmitting said video data over said wireless link to said remote wireless interface module.

5. The method of claim 4, further comprising:
using run length encoding techniques for images with wide uniform areas; and
using more complex histogram techniques for other dithered graphic images.

6. The method of claim 1, wherein said portable device is a personal computer, said method further comprising:
capturing the graphics device interface data from said computer's operating system using a resident mirror driver;
encapsulating said graphics device interface data in a proprietary data packet format;
transmitting said data packet;
receiving said data packet at said wireless interface module;
reconstructing said image; and
displaying said image at a continuous rate by means of said display device.

7. The method of claim 1, said compressing comprising:
compressing video data sourced by at least one device from the group comprised of: notebook computer, personal digital assistant, cellular telephone, palm-type computing device, digital camera, and camcorder.

8. The method of claim 1, comprising:
displaying a low-resolution thumbnail version of an image on said portable device.

9. The method of claim 1, comprising:
selecting an image from a list of available images to initiate the transfer of a corresponding compressed image to said display.

10. A method for wireless image transfer, the method comprising:
receiving video data in a wireless interface module with video data decoding/decompressing capability;
interpreting said graphics device interface commands in said wireless interface module;
decoding said video data in said wireless interface module;
decompressing said video data in said wireless interface module; and
displaying said video data on a display device.

11. The method of claim 10, said receiving comprising:
receiving video data sourced by at least one device from the group comprised of: notebook computer, personal digital assistant, cellular telephone, palm-type computing device, digital camera, and camcorder.

12. The method of claim 10, further comprising:
using digital signal processor accelerator compression techniques for compressing data originating in said portable device prior to transmitting over said wireless link; and

13. The method of claim 10, further comprising:
using digital signal processor accelerator decompression techniques in said display device for decompressing said video data prior to displaying said data.

14. A system for wireless video image data transfer from a portable device, comprising:
a portable device for generating video image data;
at least one digital signal processor accelerator selected from the group consisting of a digital signal processor compression accelerator and a digital signal processor encryption accelerator coupled to said portable device for processing said video image data; and
a transmitter embedded in said portable device for transmitting said processed video image data over a radio frequency wireless link.

15. The system of claim 14, said digital signal processor accelerator comprised of a 802.11 PCMCIA card embedded in said portable device.

16. The system of claim 14, said portable device having a mirror driver, said mirror driver operable to capture the graphics device interface data from said portable device's operating system, said data being encapsulated in a packet format, and said formatted video image data being transmitted over said wireless link.

17. The system of claim 14, said portable device operable as a Codec to:
iteratively compress sub-sampled on-screen video locally using minimal computational complex techniques, such that
transmit said video data over said wireless link to a remote wireless interface module if the level of compression is acceptable;
increase said compression complexity when said compression is unacceptable until compression is acceptable; and
transmitted said video data is over said wireless link to a remote wireless interface module.

18. A display device comprising:
a wireless interface module for receiving video image data;
at least one digital signal processor accelerator selected from the group consisting of a digital signal processor decompression accelerator and a digital signal processor decryption accelerator embedded in said wireless interface module for processing said video image data; and
a display device coupled to said wireless interface module to receive and display said processed video image data.
